(19) United States
(12) Patent Application Publication
(10) Pub. No.: US 2018/0292785 A9
(43) Pub. Date: Oct. 11, 2018

(54) APPARATUS AND METHOD FOR DISPLAYING PSEUDO-HOLOGRAM IMAGE BASED ON PUPIL TRACKING

(71) Applicant: Electronics and Telecommunications Research Institute, Daejeon (KR)

(72) Inventors: Hyon Gon CHOO, Daejeon (KR); Kyung Ae MOON, Daejeon (KR); Min Sik PARK, Sejong (KR); Hyun Eui KIM, Cheongju- si Chungcheongbuk-do (KR); Jin Woong KIM, Daejeon (KR)

(21) Appl. No.: 14/533,608

(22) Filed: Nov. 5, 2014

(30) Foreign Application Priority Data
Nov. 6, 2013 (KR) 10-2013-0134174

(51) Int. Cl. G03H 1/08; G03H 1/22

(52) U.S. Cl. CPC G03H 1/0866; G03H 1/2202; G03H 2001/0883; G03H 2001/2223; G03H 1/2205

(57) ABSTRACT

Provided are an apparatus and a method for displaying a hologram image based on pupil tracking, wherein a hologram image display apparatus includes a location determiner to determine a location of a user using a captured image of the user and a hologram information reconstructor to reconstruct first hologram information as second hologram information optimized for the location of the user to reproduce the hologram image.

### CROSS-REFERENCE TO RELATED APPLICATION

This application claims the priority benefit of Korean Patent Application No. 10-2013-0134174, filed on Nov. 6, 2013, in the Korean Intellectual Property Office, the disclosure of which is incorporated herein by reference.

### BACKGROUND

1. Field of the Invention

The present invention relates to an apparatus and a method for displaying a hologram image based on pupil tracking, and more particularly, to an apparatus and a method for determining a location of a user by detecting an eye of the user from a captured image of the user and reproducing a hologram image optimized for the user by reconstructing hologram information based on the location of the user.

2. Description of the Related Art

Among various forms of hologram image displaying technology, a pseudo-holographic technology may relate to outputting a hologram image to a space by projecting a two-dimensional (2D) image to a 2D screen using a high-resolution projector or a display. The pseudo-holographic technology may give an effect of exhibiting the hologram image reflected through the 2D screen, for example, a semitransparent mirror and a semitransparent screen, as if the hologram image floats in the space.

However, in the pseudo-holographic technology, an image to be projected to the 2D screen is a 2D image and thus, a 3D effect may decrease depending on a distance or an angle between the screen and the user.

Accordingly, there is a desire for a method of preventing the decrease in the 3D effect of the hologram image depending on a location of the user viewing the hologram image.

### SUMMARY

An aspect of the present invention provides an apparatus and a method for reproducing a hologram image optimized for a user by projecting a two-dimensional (2D) image corresponding to a location of the user to a screen.

According to an aspect of the present invention, there is provided a hologram image display apparatus including a location determiner to determine a location of a user using a captured image of the user, and a hologram information reconstructor to reconstruct first hologram information to be second hologram information optimized for the location of the user to reproduce a hologram image.

The hologram information reconstructor may reconstruct the first hologram information as the second hologram information by projecting the first hologram information to 2D coordinates corresponding to the location of the user.

When an eye of the user is detected from the image, the location determiner may determine the location of the user based on a parameter of a camera capturing the image.

The location determiner may determine three-dimensional (3D) coordinates corresponding to the location of the user based on a location of an eye of the user detected from the image and depth information received from the camera.

The hologram image display apparatus may further include a hologram reproducer to reproduce a hologram image by projecting the second hologram information to a semitransparent screen or a semitransparent mirror.

According to another aspect of the present invention, there is provided a hologram image display apparatus including a hologram information generator to generate angle based sets of hologram information using images of an object captured at each angle, an angle determiner to determine an angle between a user and a screen using a captured image of the user, and a hologram reproducer to reproduce a hologram image by projecting, to the screen, hologram information corresponding to the angle between the user and the screen among the angle based sets of hologram information.

The angle determiner may determine the angle between the user and the screen based on a gaze direction of the user.

The angle determiner may determine the gaze direction of the user based on a location of a pupil detected from the image.

According to still another aspect of the present invention, there is provided a hologram image displaying method including determining a location of a user based on a captured image of the user, and reconstructing first hologram information as second hologram information optimized for the location of the user to reproduce a hologram image.

According to yet another aspect of the present invention, there is provided a hologram image displaying method including generating angle based sets of hologram information using images of an object captured at each angle, determining an angle between a user and a screen using a captured image of the user, and reproducing a hologram by projecting hologram information corresponding to the angle between the user and the screen among the angle based sets of hologram information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an operation of a hologram image display apparatus according to an embodiment of the present invention;

FIG. 2 is a diagram illustrating a configuration of a hologram image display apparatus according to an embodiment of the present invention;

FIG. 3 is a diagram illustrating an example of feature information used by a location determiner to detect an eye according to an embodiment of the present invention;

FIG. 4 is a diagram illustrating an example of an operation of a location determiner according to an embodiment of the present invention;

FIG. 5 is a diagram illustrating an example of reconstructing hologram information based on a location of a user by a hologram image display apparatus according to an embodiment of the present invention;

FIG. 6 is a diagram illustrating another example of reconstructing hologram information based on a location of a user by a hologram image display apparatus according to an embodiment of the present invention;

FIG. 7 is a diagram illustrating a configuration of a hologram image display apparatus according to another embodiment of the present invention;

FIG. 8 is a diagram illustrating an example of selecting hologram information based on an angle between a user and a screen by a hologram image display apparatus according to an embodiment of the present invention;

FIG. 9 is a diagram illustrating another example of selecting hologram information based on an angle between a user and a screen by a hologram image display apparatus according to an embodiment of the present invention;

FIG. 10 is a flowchart illustrating a hologram image displaying method according to an embodiment of the present invention;

FIG. 11 is a flowchart illustrating a method of determining a location of a user according to an embodiment of the present invention; and

FIG. 12 is a flowchart illustrating a hologram image displaying method according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

A hologram image displaying method described herein may be performed by a hologram image display apparatus described herein.

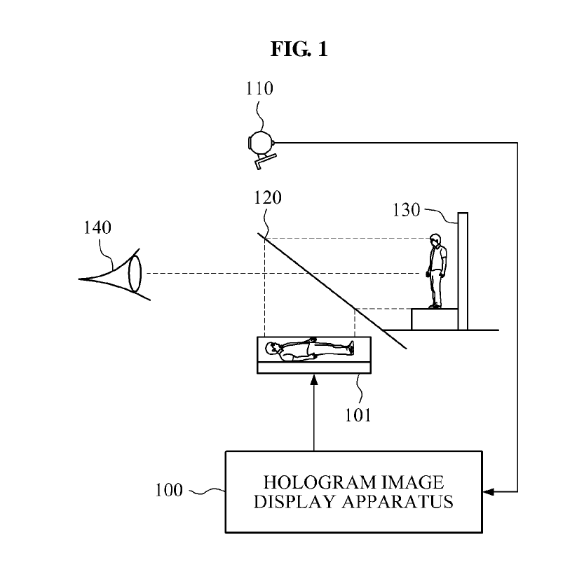

FIG. 1 is a diagram illustrating an operation of a hologram image display apparatus 100 according to an embodiment of the present invention.

The hologram image display apparatus 100 may be a pseudo-holographic image display apparatus that may output an image to a space by projecting a two-dimensional (2D) image to a 2D screen.

Referring to FIG. 1, the hologram image display apparatus 100 outputs a 2D image 101 to a 2D screen 120 through a high-resolution projector or a display. For example, the 2D screen 120 may be a semitransparent mirror or a semitransparent screen.

The 2D image 101 output by the hologram image display apparatus 100 may be reproduced as a hologram image 130 appearing to be floating in a space by being reflected to the 2D screen 120.

The hologram image display apparatus 100 may determine a location of a user 140 using a camera 110. The camera 110 may be one of a general camera, a stereo camera, and a depth camera.

The hologram image display apparatus 100 may reconstruct first hologram information for displaying the 2D image 101 to be second hologram information optimized for the location of the user 140. For example, the first hologram information may be 3D coordinates of a 3D object to reproduce the hologram image 130. The hologram image display apparatus 100 may resynthesize the 2D image 101 based on the second hologram information and output the 2D image 101 to the 2D screen 120.

Here, the hologram image display apparatus 100 may optimize the 2D image 101 for the visual field of the user 140 by identifying a location of an eye of the user 140 from a body of the user 140 and reconstructing the first hologram information as the second hologram information based on the location of the eye.

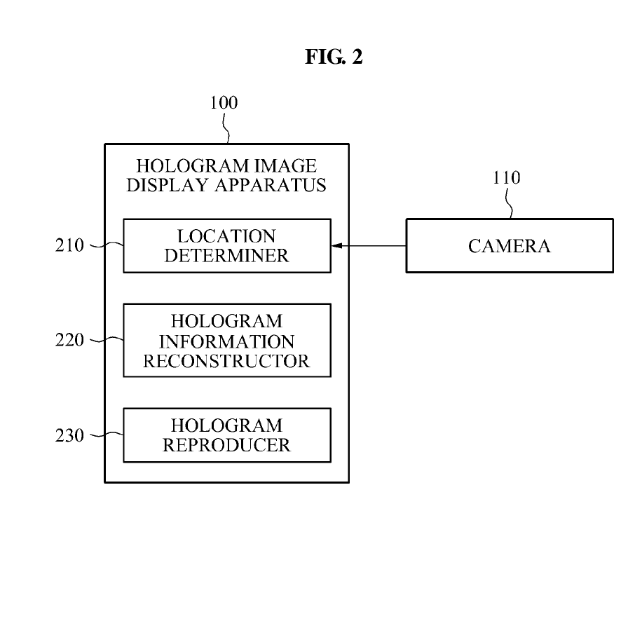

FIG. 2 is a diagram illustrating a configuration of the hologram image display apparatus 100 according to an embodiment of the present invention.

Referring to FIG. 2, the hologram image display apparatus 100 includes a location determiner 210, a hologram information reconstructor 220, and a hologram reproducer 230.

The location determiner 210 may determine a location of a user using an image of the user captured by the camera 110.

The location determiner 210 may search for a face of the user from the image captured by the camera 110 and detect a location of an eye of the user in the found face. The location determiner 210 may detect the location of the eye using an eye detector using a pupil tracking algorithm. For example, the pupil tracking algorithm may include one of a Haar feature based approach and an active appearance model (AAM) method. The Haar feature based approach may include calculating, in advance, feature information on a face image using a filter such as a Haar-like feature, comparing the calculated feature information to feature information on an input image, and analyzing whether a face is present in the input image.

When the eye of the user is detected from the image captured by the camera 110, the location determiner 210 may determine the location of the user based on a parameter of the camera 110 capturing the image.

Also, the location determiner 210 may determine 3D coordinates corresponding to the location of the user based on the location of the eye of the user and depth information received from the camera 110.

More particularly, the location determiner 210 may determine the 3D coordinates of the user based on a user capturing direction of the camera 110, the location of the eye detected from the image, and the depth information on the user.

For example, the location determiner 210 may determine user distance coordinates corresponding to a distance between the user and the camera 110 based on the depth information on the user.

The location determiner 210 may identify a direction in which the user is present based on the user capturing direction of the camera 110, and determine 3D coordinates at which the face of the user is positioned from the distance identified based on the location of the eye detected from the image.

For example, when the camera 110 is a stereo camera or a depth camera, the location determiner 210 may receive, from the camera 110, the 3D coordinates of the user measured by the camera 110. Here, the location determiner 210 may determine the location of the user based on the received 3D coordinates of the user.

For another example, when the camera 110 is a general type camera, the location determiner 210 may detect the location of the eye and a location of a pupil of the user and determine a gaze direction of the user based on a direction in which the pupil is positioned in the eye of the user. Also, the location determiner 210 may determine the location of the user based on the gaze direction of the user. For example, the location determiner 210 may determine a relative distance between the user and the camera 110 based on a distance between pupils of the user.

The hologram information reconstructor 220 may reconstruct the first hologram information as the second hologram information based on the location of the user determined by the location determiner 210. Here, the first hologram information may be default information used to reproduce a hologram image, and the second hologram information may be information used to reproduce a hologram image optimized for the location of the user. For example, when the first hologram information corresponds to 3D object data, the hologram information reconstructor 220 may reconstruct the first hologram information as the second hologram information by projecting the first hologram information to 2D coordinates corresponding to the location of the user.

For example, the hologram information reconstructor 220 may reconstruct the first hologram information as the second hologram information “P” by projecting 3D coordinates “X={Xw, Yw, Zw}” of the first hologram information to 2D coordinates “x=(x,y)” corresponding to the location of the user based on a relationship represented as Equation 1.

$$x = PX \\ [ \begin{matrix}x \\ y \\ 1\end{matrix} ] = [ \begin{matrix}{p}_{11} & {p}_{12} & {p}_{13} & {p}_{14} \\ {p}_{21} & {p}_{22} & {p}_{23} & {p}_{24} \\ {p}_{31} & {p}_{32} & {p}_{33} & {p}_{34}\end{matrix} ] [ \begin{matrix}{X}_{w} \\ {Y}_{w} \\ {Z}_{w} \\ 1\end{matrix} ] \qquad [ Equation 1 ]$$

The hologram reproducer 230 may synthesize the 2D image 101 based on the second hologram information obtained by the reconstructing performed by the hologram information reconstructor 220, and reproduce a hologram by projecting the synthesized 2D image 101 to the screen 120. Here, the hologram reproducer 230 may include a renderer to render the second hologram information to be optimized for a display and synthesize the 2D image 101 and the display to project the 2D image 101 to the screen 120.

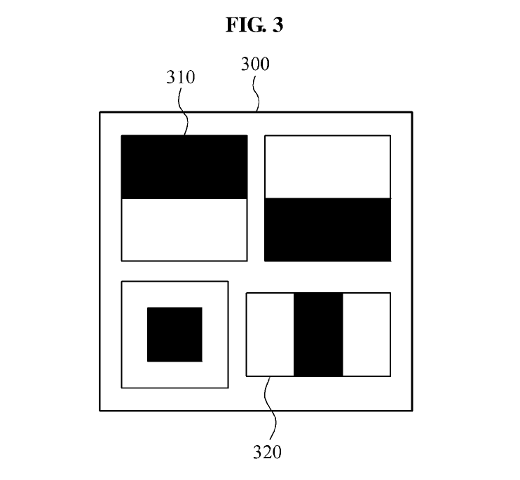

FIG. 3 is a diagram illustrating an example of feature information 300 used by the location determiner 210 to detect an eye of a user according to an embodiment of the present invention.

An eye detector of the location determiner 210 may search for a face of the user from an image captured by the camera 110, and detect a location of the eye of the user in the found face using the feature information 300.

As illustrated in FIG. 3, the feature information 300 may include information 310 used to detect eyebrows of the user and eyes positioned below the eyebrows by being laterally divided, and information 320 used to detect a noise of the user and eyes positioned to a left and a right of the noise by being vertically divided.

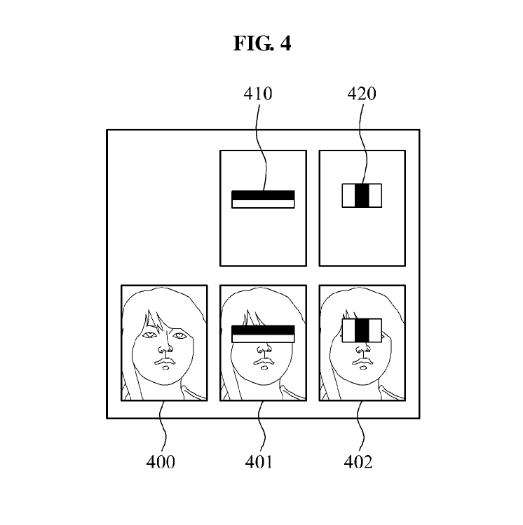

A detailed process of detecting the location of the eye of the user by the eye detector of the location determiner 210 using the feature information 300 will be further described with reference to FIG. 4.

FIG. 4 is a diagram illustrating an example of an operation of the location determiner 210 according to an embodiment of the present invention.

An eye detector of the location determiner 210 may search for a face of a user from an image 400 captured by the camera 110.

The eye detector may detect a location of an eye of the user using feature information.

For example, as illustrated in case 1 401, the eye detector may search for a region corresponding to feature information 410 from the image 400. In the face of the user, eyebrows may be darker than a skin color of the face of the user and horizontally formed. Also, an upper area indicated in black in the feature information 410 may correspond to the eyebrows of the user darker than the skin color of the face of the user. As illustrated in case 1 401, the region corresponding to the feature information 410 in the face of the user may be the eyebrows and eyes of the user positioned immediately below the eyebrows.

Thus, the eye detector may detect, as the location of the eye of the user, the region corresponding to the feature information 410 in the face of the user searched from the image 400.

For another example, as illustrated in case 2 402, the eye detector may search for a region corresponding to feature information 420 from the image 400. In the face of the user, a noise may be higher than other portions in the face of the user and thus, include different information from the other portions. Also, a middle area of a vertically divided region in the feature information 420 may be information corresponding to the noise. As illustrated in case 2 402, the region corresponding to the feature information 420 in the face of the user may be the noise of the user and the eyes of the user positioned adjacent to the noise.

Thus, the eye detector may detect, as the location of the eye of the user, the region corresponding to the feature information 420 in the face of the user searched from the image 400.

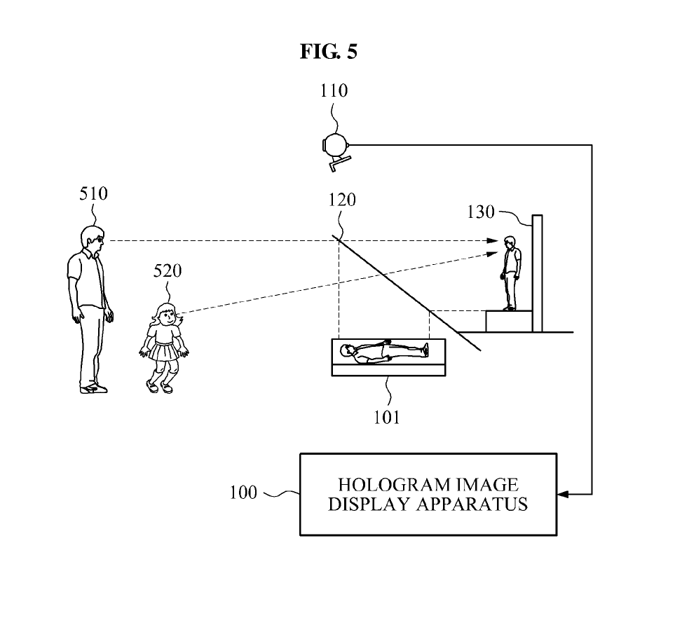

FIG. 5 is a diagram illustrating an example of reconstructing hologram information based on a location of a user by the hologram image display apparatus 100 according to an embodiment of the present invention.

FIG. 5 illustrates an example of reconstructing the hologram information based on a height of a location of an eye of the user.

When the hologram image display apparatus 100 outputs the hologram image 130 to a space by projecting the 2D image 101 to the 2D screen 120, a 3D stereo effect may be experienced differently based on a visual field of a user.

For example, a first user 510 may experience a 3D stereo effect such as the hologram image 130 based on the 2D image 101 projected to the 2D screen 120. However, a second user 520 having a shorter height or lower posture than the first user 510 may have an angle from the 2D screen 120 which is different from that of the first user 510 and thus, may experience a relatively less 3D stereo effect.

Accordingly, the hologram image display apparatus 100 my determine a location of the first user 510 or the second user 520 using the camera 110, and reconstruct first hologram information as second hologram information based on the location of the first user 510 or the second user 520.

Here, first hologram information used by the hologram image display apparatus 100 to provide the hologram image 130 to the first user 210 may be identical to first hologram information used by the hologram image display apparatus 100 to provide the hologram image 130 to the second user 520.

However, second hologram information obtained by the reconstructing performed by the hologram image display apparatus 100 to provide the hologram image 130 to the first user 510 may differ from second hologram information obtained by the reconstructing performed by the hologram image display apparatus 100 to provide the hologram image 130 to the second user 520 based on a difference between the locations of the first user 510 and the second user 520.

The hologram image display apparatus 100 may reconstruct the identical first hologram information as different sets of the second hologram information based on the locations of the first user 510 and the second user 520, and display the 2D image 101 using the second hologram information obtained by the reconstructing and thus, differently output the 2D image 101 based on each user.

The differently output 2D image 101 may be reflected on the 2D screen 120 and reproduced as the hologram image 130 by which the 3D stereo effect is most experienced from the locations of each user.

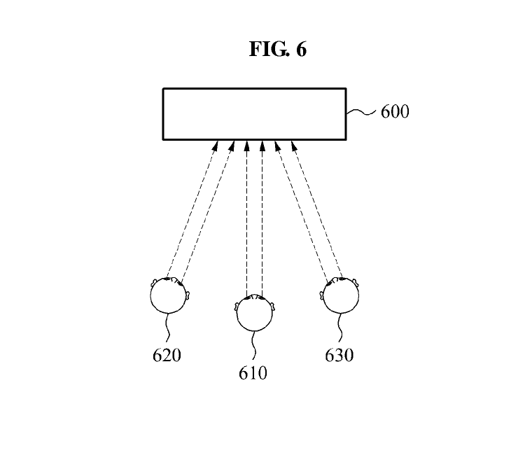

FIG. 6 is a diagram illustrating another example of reconstructing hologram information based on a location of a user by the hologram image display apparatus 100 according to an embodiment of the present invention.

FIG. 6 illustrates an example of reconstructing the hologram information based on a change in a horizontal location of the user.

When the user is assumed to view a 2D screen 600 in front, first hologram information may be used to display the 2D image 101 to output the hologram image 130 to a space.

For example, when the user is located in front 610, the hologram image display apparatus 100 may not reconstruct the first hologram information. Here, the hologram image display apparatus 100 may synthesize the 2D image 101 using the first hologram information and project the 2D image 101 to the 2D screen 600.

For another example, when the user is located on a left 620, the hologram image display apparatus 100 may determine that the location of the user is on the left 620 of the 2D screen 600 based on an image captured by the camera 110. The hologram image display apparatus 100 may reconstruct the first hologram information as second hologram information optimized for the location of the user, which is the left 620. The hologram image display apparatus 100 may synthesize the 2D image 101 using the second hologram information obtained through the reconstructing and project the 2D image 101 to the 2D screen 600. Here, the 2D image 101 to be projected to the 2D screen 600 by the hologram image display apparatus 100 may differ from the 2D image 101 synthesized using the first hologram information.

For still another example, when the user is located on a right 630, the hologram image display apparatus 100 may determine that the location of the user is on the right 630 of the 2D screen 600 based on an image captured by the camera 110. The hologram image display apparatus 100 may reconstruct the first hologram information as the second hologram information optimized for the location of the user, which is the right 630. The hologram image display apparatus 100 may synthesize the 2D image 101 using the second hologram information obtained through the reconstructing and project the 2D image 101 to the 2D screen 600. Here, the 2D image 101 to be projected to the 2D screen 600 by the hologram image display apparatus 100 may differ from the 2D image 101 synthesized using the first hologram information and the 2D image 101 synthesized using the second hologram information when the user is located on the left 620.

As described in the foregoing, when the location of the user is indicated as the three, the hologram image display apparatus 100 may synthesize and display three 2D images optimized for the respective locations of each user.

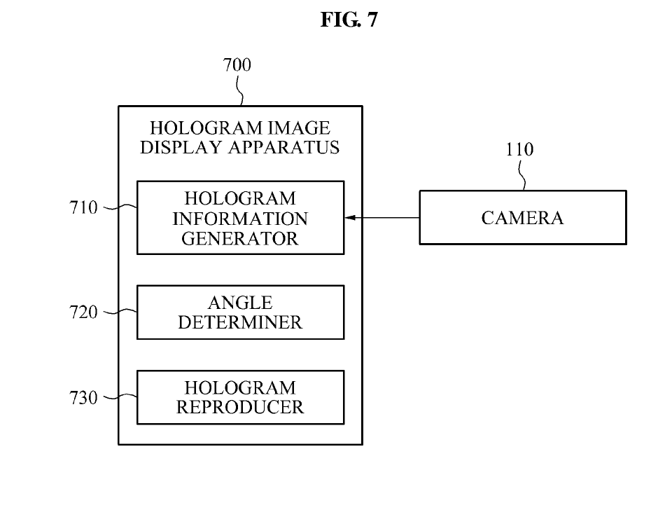

FIG. 7 is a diagram illustrating a configuration of a hologram image display apparatus 700 according to another embodiment of the present invention.

FIG. 7 illustrates an example of the hologram image display apparatus 700 that may generate plural sets of hologram information by capturing images of an object at different angles, select one of the plural sets of the hologram information based on an angle between a user and a screen, and synthesize the 2D image 101.

Referring to FIG. 7, the hologram image display apparatus 700 includes a hologram information generator 710, an angle determiner 720, and a hologram reproducer 730.

The hologram information generator 710 may receive the images of the object captured at each angle and generate angle based sets of hologram information based on the received images.

The angle determiner 720 may determine the angle between the user and the screen based on an image of the user captured by the camera 110.

For example, the angle determiner 720 may detect a location of a pupil of the user from the image. The angle determiner 720 may determine a gaze direction of the user based on the location of the pupil detected from the image. The angle determiner 720 may determine the angle between the user and the screen based on the gaze direction of the user.

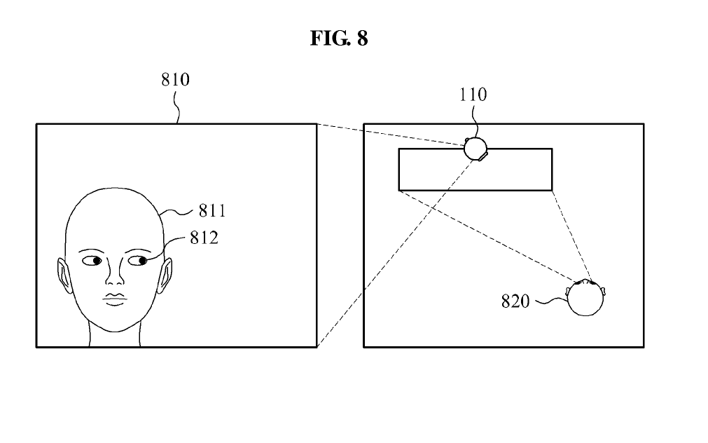

A process of determining the angle between the user and the screen by the angle determiner 720 using the gaze direction of the user will be further described with reference to FIG. 8.

Also, the angle determiner 720 may determine the angle between the user and the screen using a location of the user detected from the image and a location of the screen.

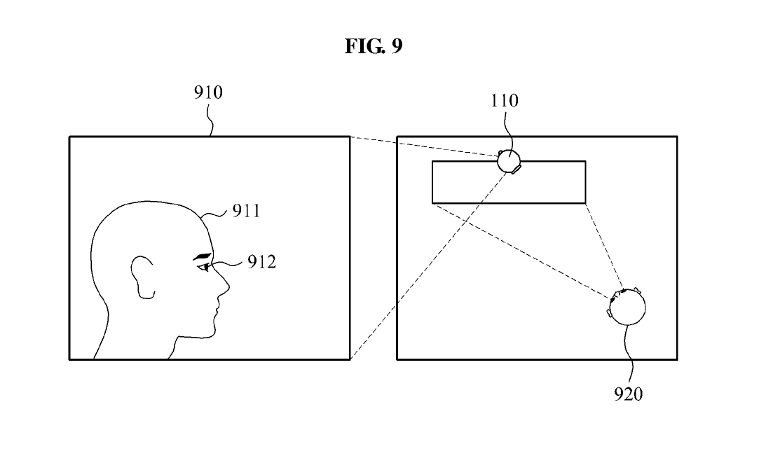

A process of determining the angle between the user and the screen by the angle determiner 720 based on the location of the user and the location of the screen will be further described with reference to FIG. 9.

The hologram reproducer 730 may select hologram information corresponding to the angle between the user and the screen from among the angle based sets of hologram information generated by the hologram information generator 710, and reproduce a hologram by projecting the selected hologram information to the 2D screen 120.

FIG. 8 is a diagram illustrating an example of selecting hologram information based on an angle between a user 820 and a screen by a hologram image display apparatus according to an embodiment of the present invention.

FIG. 8 illustrates a process of determining the angle between the user 820 and the screen by the angle determiner 720 based on a gaze direction of the user 820.

The angle determiner 720 may search for a face 811 of the user 820 from an image 810 of the user 820 captured by the camera 110, and detect a location of a pupil 812 in the face 811 of the user 820. As illustrated in FIG. 8, the pupil 812 of the user 820 is located on a right side of an eye of the user 820. That the location of the pupil 812 is the right side in the image 810 obtained by capturing the face 811 of the user 820 may indicate that the user 820 may view a left side. Thus, the angle determiner 720 may determine that the user 820 is located on a right side of the screen because the user 820 views the 2D image 101 projected to the screen.

The angle determiner 720 may determine the angle between the user 820 and the screen based on the location of the user 820 and the location of the screen.

The hologram reproducer 730 may select hologram information corresponding to an image captured from a right side of an object from among predetermined sets of hologram information.

The hologram reproducer 730 may reproduce a hologram image optimized for the user 820 located on the right side from the screen by projecting a 2D image obtained by rendering the selected hologram information to the screen.

FIG. 9 is a diagram illustrating another example of selecting hologram information based on an angle between a user 920 and a screen by a hologram image display apparatus according to an embodiment of the present invention.

FIG. 9 illustrates a process of determining the angle between the user 920 and the screen by the angle determiner 720 based on a location of the user 920 detected from an image 910 and a location of the screen.

The angle determiner 720 may search for a face 911 of the user 920 from the image 910 of the user 920 captured by the camera 110, and detect a location of an eye 912 of the user 920 in the face 911 of the user 920. As illustrated in FIG. 9, only one eye 912 of the user 920 is detected on a right side of the face 911 of the user 920.

Detection of the eye 912 in the face 911 of the user 920 may indicate that the face 911 of the user 920 included in the image 910 is a profile of the user 920. Also, when the location at which the eye 912 is detected is on a right of the face 911 may indicate that the user 920 views a left side. Thus, the angle determiner 720 may determine that the user 920 is located on the right of the screen because the user 920 views the 2D image 101 projected to the screen.

The angle determiner 720 may determine the angle between the user 920 and the screen based on the location of the user 920 and the location of the screen.

The hologram reproducer 730 may select hologram information corresponding to an image captured from a right side of an object from among predetermined sets of hologram information.

The hologram reproducer 730 may reproduce a hologram image optimized for the user 920 located on the right from the screen by projecting a 2D image obtained by rendering the selected hologram information to the screen.

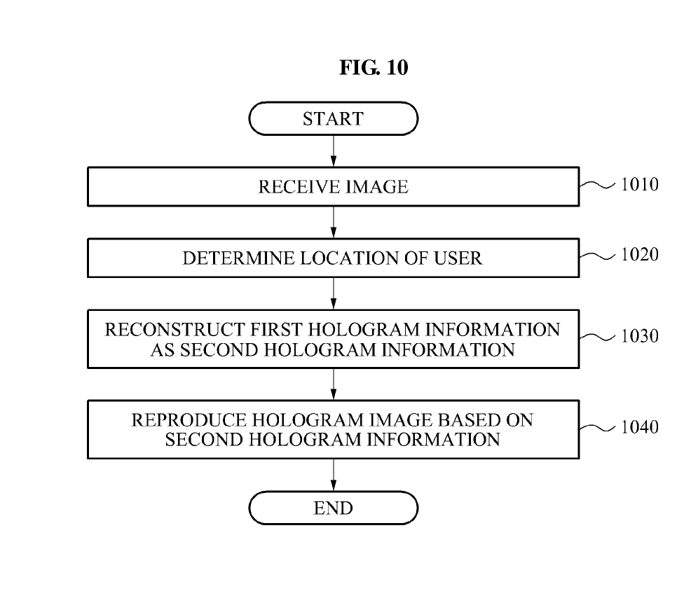

FIG. 10 is a flowchart illustrating a hologram image displaying method according to an embodiment of the present invention.

Referring to FIG. 10, in operation 1010, the location determiner 210 receives an image of a user captured by the camera 110.

In operation 1020, the location determiner 210 determines a location of the user using the image received in operation 1010.

Here, when the camera 110 is a stereo or a depth camera, the location determiner 210 may receive, from the camera 110, 3D coordinates of the user measured by the camera 110, and determine the location of the user based on the received 3D coordinates of the user.

In operation 1030, the hologram information reconstructor 220 reconstructs first hologram information as second hologram information based on the location of the user determined in operation 1010. Here, the first hologram information may be default information used to reproduce a hologram image, and the second hologram information may be information used to reproduce a hologram image optimized for the location of the user.

The hologram information reconstructor 220 may reconstruct the first hologram information as the second hologram information by projecting the first hologram information to 2D coordinates corresponding to the location of the user.

In operation 1040, the hologram reproducer 230 synthesizes the 2D image 101 based on the second hologram information obtained through the reconstructing in operation 1030, and reproduces a hologram image by projecting the synthesized 2D image 101 to the screen 120.

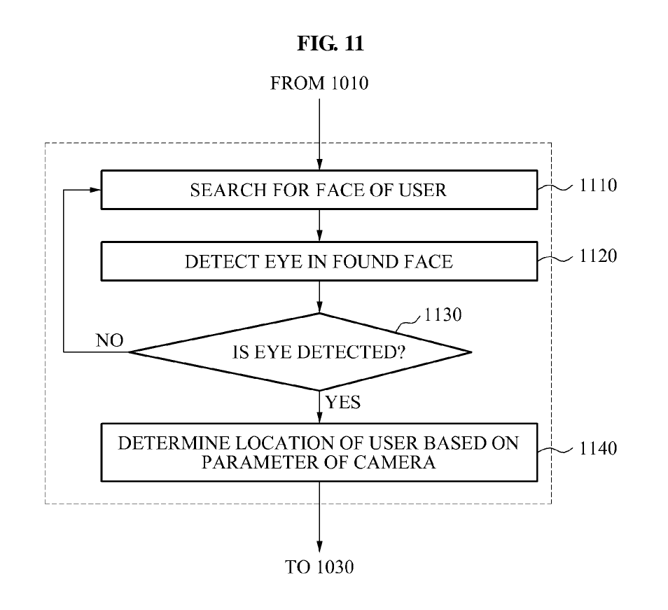

FIG. 11 is a flowchart illustrating a method of determining a location of a user according to an embodiment of the present invention. Operations 1110 through 1140 of FIG. 11 may be included in operation 1020 of FIG. 10.

Referring to FIG. 11, in operation 1110, the location determiner 210 searches for a face of the user from the image received in operation 1010.

In operation 1120, the location determiner 210 detects a location of an eye in the face found in operation 1110.

In operation 1130, the location determiner 210 determines whether the eye is detected in operation 1120.

When the eye is detected, the location determiner 210 may perform operation 1140. However, when the eye is not detected, the location determiner 210 may determine that the face found in operation 1110 is not the face of the user viewing a hologram image, and perform operation 1110 to re-search for a face from the image.

In operation 1140, the location determiner 210 determines the location of the user based on a parameter of the camera 110 capturing the image.

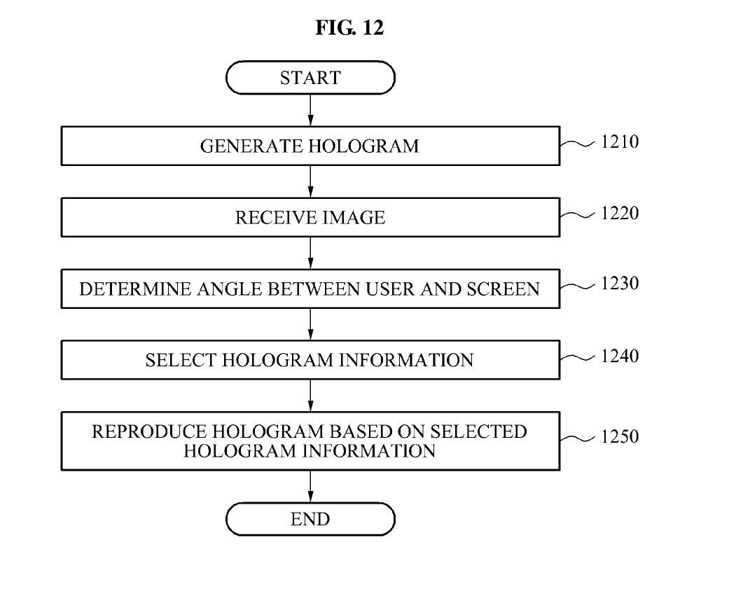

FIG. 12 is a flowchart illustrating a hologram image displaying method according to another embodiment of the present invention.

FIG. 12 illustrates a flowchart of the hologram image displaying method including generating plural sets of hologram information by capturing an image of an object at each angle, selecting one from among the plural sets of hologram information, and reproducing a hologram image.

Referring to FIG. 12, in operation 1210, the hologram information generator 710 receives images of an object captured at each angle, and generates angle based sets of hologram information based on the received images.

In operation 1220, the location determiner 210 receives an image of a user captured by the camera 110.

In operation 1230, the angle determiner 720 determines an angle between the user and a screen based on the images received in operation 1220.

For example, the angle determiner 720 may detect a location of a pupil of the user from an image. The angle determiner 720 may determine a gaze direction of the user based on the location of the pupil detected from the image. The angle determiner 720 may determine the angle between the user and the screen based on the gaze direction of the user.

In operation 1240, the hologram reproducer 730 selects hologram information corresponding to the angle between the user and the screen, which is determined in operation 1230, from among the angle based sets of hologram information generated in operation 1210.

In operation 1250, the hologram reproducer 730 reproduces a hologram image by projecting the hologram information selected in operation 1240 to the 2D screen 120.

According to an embodiment of the present invention, a hologram image optimized for a user may be reproduced by determining a location of the user using a captured image of the user and reconstructing hologram information based on the location of the user.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A hologram image display apparatus, comprising:
a location determiner to determine a location of a user using a captured image of the user; and
a hologram information reconstructor to reconstruct first hologram information to be second hologram information optimized for the location of the user to reproduce a hologram image.

2. The apparatus of claim 1, wherein the hologram information reconstructor reconstructs the first hologram information as the second hologram information by projecting the first hologram information to two-dimensional (2D) coordinates corresponding to the location of the user.

3. The apparatus of claim 1, wherein, when an eye of the user is detected from the image, the location determiner determines the location of the user based on a parameter of a camera capturing the image.

4. The apparatus of claim 3, wherein the location determiner searches for a face of the user from the image and detects the eye of the user in the found face.

5. The apparatus of claim 3, wherein the location determiner determines three-dimensional (3D) coordinates corresponding to the location of the user based on a location of the eye detected from the image and depth information received from the camera.

6. The apparatus of claim 1, further comprising:
a hologram reproducer to reproduce a hologram image by projecting the second hologram information to a semitransparent screen or a semitransparent mirror.

7. A hologram image display apparatus, comprising:
a hologram information generator to generate angle based sets of hologram information using images of an object captured at each angle;
an angle determiner to determine an angle between a user and a screen using a captured image of the user; and
a hologram reproducer to reproduce a hologram image by projecting, to the screen, hologram information corresponding to the angle between the user and the screen among the angle based sets of hologram information.

8. The apparatus of claim 7, wherein the angle determiner determines the angle between the user and the screen based on a gaze direction of the user.

9. The apparatus of claim 8, wherein the angle determiner determines the gaze direction of the user based on a location of a pupil detected from the image.

10. The apparatus of claim 9, wherein the angle determiner determines the angle between the user and the screen based on a location of the user detected from the image and a location of the screen.

11. A hologram image displaying method, comprising:
determining a location of a user using a captured image of the user; and
reconstructing first hologram information as second hologram information optimized for the location of the user to reproduce a hologram image.

12. The method of claim 11, wherein the reconstructing is performed by projecting the first hologram information to two-dimensional (2D) coordinates corresponding to the location of the user.

13. The method of claim 11, wherein, when an eye of the user is detected from the image, the determining is performed based on a parameter of a camera capturing the image.

14. The method of claim 13, wherein the determining comprises searching for a face of the user from the image and detecting the eye of the user in the found face.

15. The method of claim 13, wherein the determining comprises determining three-dimensional (3D) coordinates corresponding to the location of the user based on the location of the eye of the user detected from the image and depth information received from the camera.

16. The method of claim 11, further comprising:
reproducing a hologram image by projecting the second hologram information to a semitransparent screen or a semitransparent mirror.

17. A hologram image displaying method, comprising:
generating angle based sets of hologram information using images of an object captured at each angle;
determining an angle between a user and a screen using a captured image of the user; and
reproducing a hologram image by projecting hologram information corresponding to the angle between the user and the screen among the angle based sets of hologram information.

18. The method of claim 17, wherein the determining of the angle is performed based on a gaze direction of the user.

19. The method of claim 18, wherein the determining of the angle comprises determining the gaze direction of the user based on a location of a pupil detected from the image.

20. The method of claim 19, wherein the determining of the angle is performed based on a location of the user detected from the image and a location of the screen.
